(19) United States
(12) Patent Application Publication
(10) Pub. No.: US 2017/0093816 A1
(43) Pub. Date: Mar. 30, 2017

(54) REMOTE ENCRYPTION METHOD AND CRYPTOGRAPHIC CENTER

(71) Applicant: HON HAI PRECISION INDUSTRY CO., LTD., New Taipei (TW)

(72) Inventors: TUNG-TSO TSAI, New Taipei (TW); JUNG-YI LIN, New Taipei (TW); CHIH-YUAN CHUANG, New Taipei (TW); CHIH-TE LU, New Taipei (TW); CHIN-PIN KUO, New Taipei (TW); TSUNG-YUAN TU, New Taipei (TW); YU-CHENG CHEN, New Taipei (TW)

(21) Appl. No.: 14/953,613

(22) Filed: Nov. 30, 2015

(30) Foreign Application Priority Data
Sep. 24, 2015 (TW) 104131664

(51) Int. Cl. H04L 29/06; H04L 9/00; G06F 21/60

(52) U.S. Cl. CPC H04L 63/0471; G06F 21/602; H04L 63/0442; H04L 9/006; H04L 63/045; H04L 2209/76

(57) ABSTRACT

A remote encryption method is executed by at least one processor of a cryptographic center. The cryptographic center connects to a sending end and to at least one receiving end. Data and a list listing at least one receiving end to which the data is to be sent are received from the sending end. A public key corresponding to the at least one receiving end listed in the received list is obtained. The received data is asymmetrically encrypted using the obtained public key corresponding to the at least one receiving end. The encrypted data is sent to the corresponding receiving end.

### CROSS-REFERENCE TO RELATED APPLICATIONS

This application claims priority to Taiwan Patent Application No. 104131664 filed on Sep. 24, 2015, the contents of which are incorporated by reference herein.

### FIELD

The subject matter herein generally relates to data security.

### BACKGROUND

When a sending end wants to send data to a receiving end, the sending end can asymmetrically encrypt the data using a public key of the receiving end before sending the data to the receiving end to make sure the security of the transmission channel between the sending end and the receiving end.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one example embodiment of a remote encryption system.

FIG. 2 is a flowchart of one example embodiment of a remote encryption method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure, including the accompanying drawings, is illustrated by way of examples and not by way of limitation. It should be noted that references to “an” or “one” embodiment in this disclosure are not necessarily to the same embodiment, and such references mean “at least one”.

The term “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

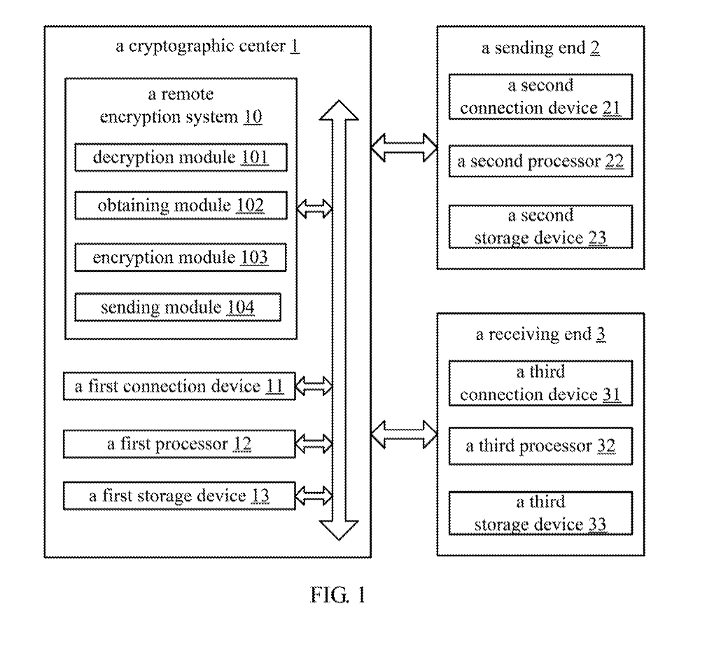

FIG. 1 is a block diagram of one example embodiment of a remote encryption system. The remote encryption system 10 is executed in a cryptographic center 1 which is connected to a sending end 2 and to at least one receiving end 3 (FIG. 1 shows only one). The cryptographic center 1 includes a first connection device 11. The sending end 2 includes a second connection device 21. The receiving end 3 includes a third connection device 31. The cryptographic center 1 connects to the sending end 2 and the at least one receiving end 3 through the first connection device 11, the second connection device 21 and the third connection device 31. The first connection device 11, the second connection device 21 and the third connection device 31 can be, but are not limited to, WI-FI devices, BLUETOOTH devices, network adapters, or other connection devices. The cryptographic center 1 can be one or more servers. The sending end 2 and the at least one receiving end 3 can be, but are not limited to, mobile phones, tablet computers, computers, or other devices sending or receiving encrypted data.

When the sending end 2 wants to send data to at least one receiving end 3, the sending end 2 sends to the cryptographic center 1 the data and a list listing at least one receiving end 3 to which the data is to be sent. When receiving the data and the list, the cryptographic center 1 obtains a public key corresponding to the at least one receiving end 3 listed in the received list, and asymmetrically encrypts the data using the obtained public key corresponding to the at least one receiving end 3, and sends the encrypted data to the corresponding receiving end 3. In some embodiments, the cryptographic center 1 stores a public key of the sending end 2 and the public key corresponding to the at least one receiving end 3. In other embodiments, the cryptographic center 1 can obtain the public key corresponding to the at least one receiving end 3 from other sources according to the information in the received list, such as by downloading from a preset web or certificating authority.

The cryptographic center 1 also includes, but is not limited to, a first processor 12 and a first storage device 13. The sending end 2 also includes, but is not limited to, a second processor 22 and a second storage device 23. The receiving end 3 also includes, but is not limited to, a third processor 32 and a third storage device 33. The first processor 12, the second processor 22, and the third processor 32 can be any of central processing units (CPU), microprocessors, or other data processor chips that perform functions. The first storage device 13, the second storage device 23, and the third storage device 33 can include various type(s) of non-transitory computer-readable storage mediums. For example, the first storage device 13, the second storage device 23, and the third storage device 33 can be internal storage systems, such as flash memories, random access memories (RAM) for temporary storage of information, and/or read-only memories (ROM) for permanent storage of information. The first storage device 13, the second storage device 23, and the third storage device 33 can also be external storage systems, such as hard disks, storage cards, or data storage mediums. The first storage device 13 is used to store a private key of the cryptographic center 1 and programs installed in the cryptographic center 1. The second storage device 23 is used to store a private key of the sending end 2 and programs installed in the sending end 2. The third storage device 33 is used to store a private key of the receiving end 3 and programs installed in the receiving end 3.

The sending end 2 is used to send data and a list to the cryptographic center 1, the list listing at least one receiving end 3 to which the data is to be sent. The data (represented by “A”) to be sent can be any information that the sending end 2 wants to send to the at least one receiving end 3. The list (represented by “C”) which is sent to the cryptographic center 1 includes identification information of the at least one receiving end 3. The identification information of the at least one receiving end 3 is used to verify the receiving end 3 and to obtain a public key of each receiving end 3. The identification information can be media access control address of the receiving end 3, email address of the receiving end 3, and so on.

In some embodiments, the data A sent to the cryptographic center 1 further includes an electronic signature (represented by “B”). The electronic signature B can be used to verify the integrity of the data and identify the sending end 2. In other embodiments, the data A sent to the cryptographic center 1 does not include an electronic signature.

In some embodiments, the sending end 2 processes the data A and the list C in a default manner before sending A and C to the cryptographic center 1 to make sure the security of the transmission channel between the sending end 2 and the cryptographic center 1. The processing can be obtaining a public key of the cryptographic center 1 and asymmetrically encrypting the data A and the list C using the public key of the cryptographic center 1. The processing also can be symmetrically encrypting the data A and the list C using a symmetric key. The symmetric key can be generated according to a key agreement protocol. In other embodiments, the sending end 2 does not process the data A and the list C before sending to the cryptographic center 1. The public key of the cryptographic center 1 can be obtained from the cryptographic center 1 or other sources, such as by downloading from a preset web or a certificating authority.

The cryptographic center 1 is used to receive the data A and the list C listing the at least one receiving end 3 from the sending end 2, obtain the public key corresponding to the at least one receiving end 3 in the list C, asymmetrically encrypt the data A using the obtained public key corresponding to the at least one receiving end 3, and send the encrypted data to the corresponding receiving end 3.

If the sending end 2 processes the data A and the list C in a default manner before sending to the cryptographic center 1 to make sure the security of the transmission channel between the sending end 2 and the cryptographic center 1, the cryptographic center 1 also processes the received data to obtain the data A and the list C. The processing by the cryptographic center 1 can be asymmetrically decrypting the received data using a private key of the cryptographic center 1 or symmetrically decrypting the received data using a symmetric key.

The receiving end 3 is used to receive the encrypted data from the cryptographic center 1, and asymmetrically decrypt the encrypted data using a private key of the receiving end 3 itself to obtain the data A which the sending end 2 wants to send. If the data A sent by the sending end 2 includes an electronic signature B, the receiving end 3 obtains a public key of the sending end 2, and verifies the integrity of the data and the identity of the sending end 2 according to the electronic signature B and the public key of the sending end 2. The public key of the sending end 2 can be obtained from the cryptographic center 1 or from other sources, such as a preset web or a certificating authority according to the information in the received list C.

FIG. 1 illustrates in at least one embodiment, the remote encryption system 10 can include a decryption module 101, an obtaining module 102, an encryption module 103, and a sending module 104. The modules 101-104 can include computerized codes in the form of one or more programs, which are stored in the first storage device 13. The first processor 12 executes the computerized codes to provide the remote encryption system 10.

If the sending end 2 has processed the data A and the list C in a default manner before sending to the cryptographic center 1 to make sure the security of the transmission channel between the sending end 2 and the cryptographic center 1, the decryption module 101 processes the received data to obtain the data A which the sending end 2 wants to send and the list C listing the at least one receiving end 3. The processing by the decryption module 101 can be asymmetrically decrypting the received data using the private key of the cryptographic center 1 or symmetrically decrypting the received data using a symmetric key. If the sending end 2 has asymmetrically encrypted the data A and the list C using the public key of the cryptographic center 1, the decryption module 101 asymmetrically decrypts the received data using a private key of the cryptographic center 1 to obtain the data A and the list C. If the sending end 2 symmetrically encrypts the data A and the list C using a symmetric key.

The obtaining module 102 is used to obtain a public key corresponding to the at least one receiving end 3 according to identification information in the received list C. In some embodiments, the cryptographic center 1 stores the public key of the sending end 2 and the public key corresponding to the at least one receiving end 3. In other embodiments, the obtaining module 102 can obtain the public key corresponding to the at least one receiving end 3 from other sources according to identification information in the received list C.

The encryption module 103 is used to asymmetrically encrypt the data A and the list C using the obtained public key corresponding to the at least one receiving end 3.

The sending module 104 is used to send the encrypted data to the corresponding receiving end 3. The sending module 104 sends the encrypted data to the receiving end 3 whose public key was used to encrypt the data. The sending module 104 can send the encrypted data through public transmission channels.

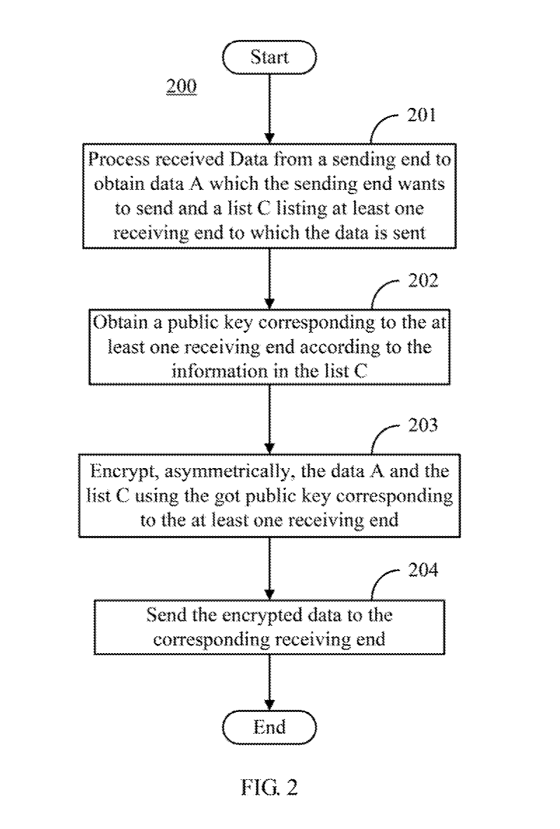

Referring to FIG. 2, a flowchart is presented in accordance with an example embodiment. The example method 200 is provided by way of example, as there are a variety of ways to carry out the method. The example method 200 described below can be carried out using the configurations illustrated in FIG. 1, for example, and various elements of these figures are referenced in explaining the example method 200. Each block shown in FIG. 2 represents one or more processes, methods, or subroutines, carried out in the example method 200. Furthermore, the illustrated order of blocks is illustrative only and the order of the blocks can be changed. Additional blocks can be added or fewer blocks may be utilized without departing from this disclosure. The example method 200 can begin at block 201.

At block 201, a decryption module is used to process the received data to obtain the data A which a sending end wants to send and the list C listing the at least one receiving end to which the data is sent, if the sending end has processed the data A and the list C in a default manner before sending to a cryptographic center to make sure the security of the transmission channel between the sending end and the cryptographic center. The processing by the decryption module can be asymmetrically decrypting the received data using a private key of the cryptographic center or symmetrically decrypting the received data using a symmetric key. If the sending end has asymmetrically encrypted the data A and the list C using the public key of the cryptographic center, the decryption module asymmetrically decrypts the received data using a private key of the cryptographic center to obtain the data A and the list C. If the sending end has symmetrically encrypted the data A and the list C using a symmetric key, the decryption module symmetrically decrypts the received data using the symmetric key to obtain the data A and the list C.

At block 202, an obtaining module is used to obtain a public key corresponding to the at least one receiving end according to identification information in the received list C. In some embodiments, the cryptographic center stores the public key of the sending end and the public key corresponding to the at least one receiving end. In other embodiments, the obtaining module can obtain the public key corresponding to the at least one receiving end from other sources according to identification information in the received list C, such as from a preset web or a certificating authority.

At block 203, a encryption module is used to asymmetrically encrypt the data A and the list C using the obtained public key corresponding to the at least one receiving end.

At block 204, a sending module is used to send the encrypted data to the corresponding receiving end. The sending module sends the encrypted data to the receiving end whose public key was used to encrypt the data. The sending module can send the encrypted data through public transmission channels.

When receiving the encrypted data from the cryptographic center, the receiving end asymmetrically decrypt the encrypted data using a private key of the receiving end itself to obtain the data A which the sending end wants to send. If the data

A sent by the sending end includes an electronic signature B, the receiving end can obtain a public key of the sending end, and verify the integrity of the data and the identity of the sending end according to the electronic signature B and the public key of the sending end. The public key of the sending end can be obtain from the cryptographic center or from other sources, such as a preset web or a certificating authority according to the information in the received list C.

It should be noted that, the public keys in the specification can be generated by a certification authority of a public key infrastructure system, or be generated by a generation center of some other system (such as a certificateless public key system).

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A remote encryption method executable by at least one processor of a cryptographic center, the cryptographic center connecting to a sending end and at least one receiving end, the method comprising:
receiving data and a list from the send end, the list listing at least one receiving end to which the data is to be sent;
obtaining a public key corresponding to the at least one receiving end listed in the received list;
asymmetrically encrypting the received data using the obtained public key corresponding to the at least one receiving end; and
sending the encrypted data to the corresponding receiving end.

2. The method according to claim 1, wherein the data received from the sending end comprises an electronic signature.

3. The method according to claim 1, wherein the public key is generated by a certification authority of a public key infrastructure system or generated by a certification authority of a certificateless public key system.

4. The method according to claim 1, further comprising:
asymmetrically decrypting the received data using a private key of the cryptographic center, if the data received from the sending end is asymmetrically encrypted using a public key of the cryptographic center.

5. The method according to claim 1, further comprising:
symmetrically decrypting the received data using a symmetric key, if the data received from the sending end is symmetrically encrypted using the symmetric key.

6. A cryptographic center comprising:
at least one processor;
a connection device used to connect to a sending end and at least one receiving end;
a storage device that stores one or more programs, when executed by the at least one processor, causers the at least one processor to:
receive data and a list from the send end, the list listing at least one receiving end to which the data is to be sent;
obtain a public key corresponding to the at least one receiving end listed in the received list;
asymmetrically encrypt the received data using the obtained public key corresponding to the at least one receiving end; and
send the encrypted data to the corresponding receiving end.

7. The cryptographic center according to claim 6, wherein the data received from the sending end includes an electronic signature.

8. The cryptographic center according to claim 6, wherein the public key is generated by a public key infrastructure system or generated by a certification authority of a certificateless public key system.

9. The cryptographic center according to claim 6, wherein at least one processor further:
asymmetrically decrypts the received data using a private key of the cryptographic center, if the data received from the sending end is asymmetrically encrypted using a public key of the cryptographic center.

10. The cryptographic center according to claim 6, wherein at least one processor further:
symmetrically decrypts the received data using a symmetric key, if the data received from the sending end is symmetrically encrypted using the symmetric key.

11. A non-transitory storage medium having stored thereon instruction that, when executed by at least one processor of a cryptographic center, causers the at least one processor to perform a remote encryption method, the cryptographic center connecting to a sending end and at least one receiving end, the method comprising:
receiving data and a list from the send end, the list listing at least one receiving end to which the data is to be sent;
obtaining a public key corresponding to the at least one receiving end listed in the received list;
asymmetrically encrypting the received data using the obtained public key corresponding to the at least one receiving end; and
sending the encrypted data to the corresponding receiving end.

12. The non-transitory storage medium according to claim 11, wherein the data received from the sending end comprises an electronic signature.

13. The non-transitory storage medium according to claim 11, wherein the public key is generated by a certification authority of a public key infrastructure system or generated by a certification authority of a certificateless public key system.

14. The non-transitory storage medium according to claim 11, wherein the method further comprising:
asymmetrically decrypting the received data using a private key of the cryptographic center, if the data received from the sending end is asymmetrically encrypted using a public key of the cryptographic center.

15. The non-transitory storage medium according to claim 11, wherein the method further comprising:
symmetrically decrypting the received data using a symmetric key, if the data received from the sending end is symmetrically encrypted using the symmetric key.
